(19) United States
(12) Patent Application Publication
(10) Pub. No.: US 2006/0066168 A1
(43) Pub. Date: Mar. 30, 2006

(54) Bonded rotor laminations

(76) Inventor: Boris A. Shoykhet, Beachwood, OH (US)

Correspondence Address: ROCKWELL AUTOMATION, INC./(FY), ATTENTION: SUSAN M. DONAHUE, 1201 SOUTH SECOND STREET, MILWAUKEE, WI, 53204, US

(21) Appl. No.: 10/955,299

(22) Filed: Sep. 30, 2004

(51) Int. Cl. H02K 17/16; H02K 17/22; H02K 19/14

(52) U.S. Cl. 310/211; 310/217

(57) ABSTRACT

In accordance with an exemplary embodiment, the present technique provides a rotor assembly formed of a plurality of rotor laminations that are bonded to one another. Specifically, the rotor laminations are bonded to one another via a bonding agent disposed between end surfaces of adjacent rotor laminations. Advantageously, the bonding of the rotor laminations increases the overall stiffness of the rotor assembly, thereby facilitating high-speed operation. Moreover, the bonding of the rotor laminations increases the consistency in construction of the rotor assembly, thereby facilitating more accurate modeling of the rotor assembly.

### BACKGROUND

The present technique relates generally to the field of electric motors and, particularly, to rotors for induction motors, such as a squirrel cage rotor, for example.

Electric motors of various types are commonly found in industrial, commercial, and consumer settings. In industry, such motors are employed to drive various kinds of machinery, such as pumps, conveyors, compressors, fans and so forth, to mention only a few. Conventional alternating current (ac) electric motors may be constructed for single- or multiple-phase power, and are typically designed to operate at predetermined speeds or revolutions per minute (rpm), such as 3600 rpm, 1800 rpm, 1200 rpm, and so on, or for the continuously changing speed within the certain speed range. The latter is called variable speed operation. Such motors generally include a stator comprising a multiplicity of windings surrounding a rotor, which is supported by bearings for rotation in the motor frame. Typically, the rotor comprises a core formed of a series of magnetically conductive laminations arranged to form a lamination stack capped at each end by electrically conductive end rings. Additionally, typical rotors include a series of conductors that are formed of a nonmagnetic, electrically conductive material and that extend through the rotor core. These conductors are electrically coupled to one another via the end rings, thereby forming one or more closed electrical pathways.

In the case of ac motors, applying ac power to the stator windings induces a current in the rotor, specifically in the conductors. The electromagnetic relationships between the rotor and the stator cause the rotor to rotate. The speed of this rotation is typically a function of the frequency of ac input power (i.e., frequency) and of the motor design (i.e., the number of poles defined by the stator windings). A rotor shaft extending through the motor housing takes advantage of this produced rotation and translates the rotor's movement into a driving force for a given piece of machinery. That is, rotation of the shaft drives the machine to which it is coupled.

Often, design parameters call for relatively high rotor rotation rates, i.e., high rpm's. By way of example, a rotor within an induction motor may operate at 14,000 rpm, and beyond. Based on the diameter of the rotor, operation at such rpm's translates into relatively high surface speeds on the rotor. Again, by way of example, rotor surface speeds may reach values of 200 meters per second (mps), and beyond. During operation, particularly during high-speed operation, it is desirable to mitigate the occurrence of resonance in the motor. Indeed, resonance in the motor can lessen performance of the motor and, in certain instances, lead to a malfunction of the motor. For example, if the stiffness of the rotor is not sufficient, the first natural frequency of variable speed motor may be below the maximal operational frequency, and, as such, difficulties in operating the motor at a speed corresponding to the first natural frequency often arise.

Typically the rotor laminations are not connected to each other in any way, so that the lamination stack is held together or by the shrink fit between the shaft and the laminations, or by the electrically conductive end rings and by the electrical conductors, or by additional plates located at the ends of the stack and connected to the rotor shaft, or by combination of the above. Accordingly, traditional rotors present inconsistencies with respect to stiffness of the rotor assembly, because of the uncertainty of the bending stiffness of the lamination stack. Unfortunately, the inconsistencies in the stiffness of the rotor hinder accurate modeling of the rotor assembly. That is to say, an inconsistency in the stiffness of the rotor impedes accurate prediction of the rotor's dynamic behavior.

Furthermore, traditional rotors present inconsistencies with respect to stiffness of the rotor assembly, because of the uncertainty of the bending stiffness of the lamination stack. Unfortunately, these inconsistencies in the stiffness of the rotor hinder accurate modeling of the rotor assembly. That is to say, inconsistencies in the stiffness of the rotor impeded accurate prediction of the rotor's dynamic behavior.

There is a need, therefore, for an improved rotor and rotor construction technique.

### BRIEF DESCRIPTION

According to an exemplary embodiment, the present technique provides a rotor lamination for a motor rotor. The rotor lamination has an outer periphery that defines a generally circular lamination cross-section and an inner periphery that defines a central aperture configured to receive a rotor shaft therethrough. The exemplary lamination also has first and second end surfaces that extend from the outer periphery to the inner periphery and that are generally parallel to one another. Extending between the first and second end surfaces are a plurality of enclosed rotor-slots that are disposed concentrically about the central aperture. These rotor-slots extend generally transverse to the lamination cross-section. Additionally, the exemplary lamination has a bonding agent that is disposed on at least one of the first and second end surfaces. Advantageously, the bonding agent increases the stiffness of a rotor core formed of the exemplary lamination.

In accordance with another embodiment, the present technique provides a rotor for use in an electric motor. The rotor comprises a rotor core formed of a plurality of rotor laminations stacked with respect to one another. The rotor laminations cooperate to form enclosed rotor-slots and a central aperture that extend through the rotor core generally transverse to the rotor core's cross-section. The exemplary rotor also includes a rotor shaft disposed in the shaft chamber and a plurality of electrically conductive members disposed in the rotor channels. To increase the stiffness of the rotor assembly, a bonding agent located between at least one pair of adjacent rotor laminations is configured to bond the at least one pair of adjacent rotor laminations to one another. Advantageously, bonding of the rotor laminations facilitates operation of the rotor at higher speeds, i.e., high-speed operation.

In accordance with yet another embodiment, the present technique provides a method of manufacturing a rotor lamination. The exemplary method includes the act of providing a rotor lamination that has a generally circular cross-section and first and second end surfaces that extend from the outer periphery to an inner periphery of the rotor lamination, wherein the first and second end surfaces are generally parallel to one another. By way of example, the rotor lamination may be provided via a fabrication process, such as stamping or laser cutting. The exemplary process also includes the act of applying a bonding agent to at least one of the first and second end surfaces. By way of example, the bonding agent may be applied to the lamination by dipping the rotor lamination into a container of the bonding agent. Alternatively, the bonding agent may be applied via a spray coating process.

In accordance with yet another embodiment, the present technique provides a method for fabricating a rotor core. The exemplary method includes the act of aligning a plurality of rotor laminations with respect to one another to form a rotor core that has a central shaft chamber and a plurality of rotor channels that both extend through the rotor core generally transverse to the core's cross-section. Additionally, the exemplary method includes placing a plurality of conducting members into the plurality of rotor channels. Furthermore, the exemplary method includes the act of bonding at least one pair of adjacent laminations with respect to one another. Advantageously, bonding a pair of adjacent laminations with respect to one another increases the stiffness of the rotor core.

### DRAWINGS

These and other features, aspects, and advantages of the present technique will become better understood when the following detailed description is read with reference to the accompanying drawings in which like characters represent like parts throughout the drawings, wherein:

FIG. 1 is a perspective view of an induction motor, in accordance with an embodiment of the present technique;

FIG. 2 is a partial cross-section view of the motor of FIG. 1 along line 2-2;

FIG. 3 is an exploded perspective view of a set of adjacent rotor laminations, in accordance with an embodiment of the present technique;

FIG. 4 is a detail view of a section of the rotor assembly of FIG. 2 within line 4-4; and

FIG. 5 is a block diagram representative of an exemplary process for construction of a rotor, in accordance with an embodiment of the present technique.

### DETAILED DESCRIPTION

As discussed in detail below, embodiments of the present technique provide apparatus and methods for rotors and rotor construction. Although the following discussion focuses on induction motors, the present technique also affords benefits to a number of applications in which the rotor integrity is a concern. Indeed, the present technique is applicable to any number of induction motor and generators as well as non-induction based motors and generators. Accordingly, the following discussion provides exemplary embodiments of the present technique and, as such, should not be viewed as limiting the appended claims to the embodiments described.

Additionally, as a preliminary matter, the definition of the term “or” for the purposes of the following discussion and the appended claims is intended to be an inclusive “or.” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “‘A’ or ‘B’” includes: “A” by itself, “B” by itself, and any combination thereof, such as “AB” and/or “BA.”

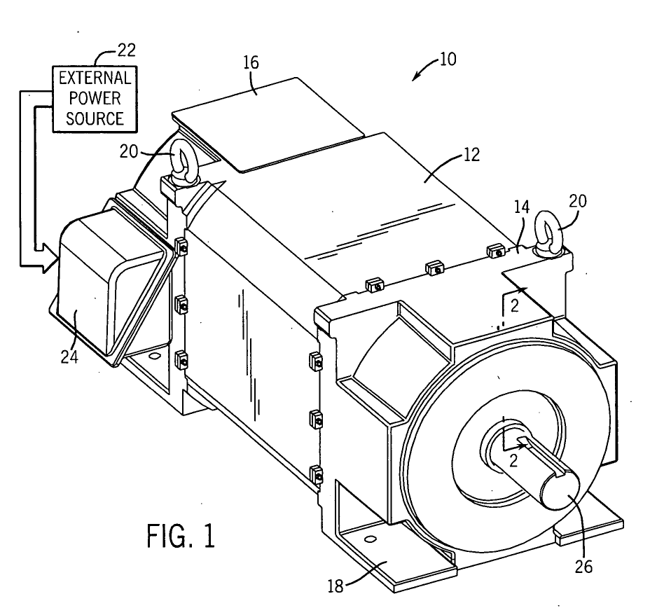

Turning to the drawings, FIG. 1 illustrates an exemplary electric motor 10. In the embodiment illustrated, the motor 10 comprises an induction motor housed in a National Electrical Manufacturers' Association (NEMA) motor housing. As appreciated by those of ordinary skill in the art, associations such as NEMA develop particular standards and parameters for the construction of motor housings or enclosures. The exemplary motor 10 comprises a frame 12 capped at each end by front and rear endcaps 14 and 16, respectively. The frame 12 and the front and rear endcaps 14 and 16 cooperate to form the enclosure or motor housing for the motor 10. The frame 12 and the front and rear endcaps 14 and 16 may be formed of any number of materials, such as cast iron, steel, aluminum, or any other suitable structural material. The endcaps 14 and 16 may include mounting and transportation features, such as the illustrated mounting flanges 18 and eyehooks 20. Those skilled in the art will appreciate in light of the following description that a wide variety of motor configurations and devices may employ the construction techniques outlined below.

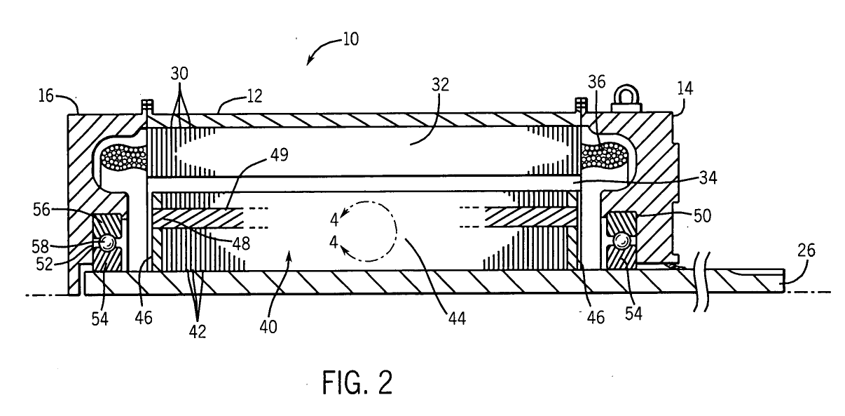

To induce rotation of the rotor, current is routed through stator windings disposed in the stator. (See FIG. 2.) Stator windings are electrically interconnected to form groups which are, in turn, interconnected in a manner generally known in the pertinent art. The stator windings are further coupled to terminal leads (not shown), which electrically connect the stator windings to an external power source 22, such as 480 Vac three-phase power or 110 Vac single-phase power. As another example, the external power source 22 may comprise an ac pulse width modulated (PWM) inverter. A conduit box 24 houses the electrical connection between the terminal leads and the external power source 22. The conduit box 24 comprises a metal or plastic material and, advantageously, provides access to certain electrical components of the motor 10. Routing electrical current from the external power source 22 through the stator windings produces a magnetic field that induces rotation of the rotor. A rotor shaft 26 coupled to the rotor rotates in conjunction with the rotor. That is, rotation of the rotor translates into a corresponding rotation of the rotor shaft 26. As appreciated by those of ordinary skill in the art, the rotor shaft 26 may couple to any number of drive machine elements, thereby transmitting torque to the given drive machine element. By way of example, machines such as pumps, compressors, fans, conveyors, and so forth, may harness the rotational motion of the rotor shaft 26 for operation.

During operation, centripetal and centrifugal forces are produced in the rotor. If not accounted for, these forces may strain various components of the rotor, thereby leading to losses in performance and, in certain instances, failure of the rotor. Accordingly, as discussed further below, the exemplary rotor includes features that improve the mechanical integrity of the rotor and that facilitate operation of the rotor at higher speeds.

FIG. 2 is a partial cross-section view of the motor 10 of FIG. 1 along line 2-2. To simplify the discussion, only the top portion of the motor 10 is shown, as the structure of the motor 10 is essentially mirrored along its centerline. As discussed above, the frame 12 and the front and rear endcaps 14 and 16 cooperate to form an enclosure or motor housing for the motor 10. Within the enclosure or motor housing resides a plurality of stator laminations 30 juxtaposed and aligned with respect to one another to form a lamination stack, such as a contiguous stator core 32. In the exemplary motor 10, the stator laminations 30 are substantially identical to one another, and each includes features that cooperate with adjacent laminations to form cumulative features for the contiguous stator core 32. For example, each stator lamination 30 includes a central aperture that cooperates with the central aperture of adjacent laminations to form a rotor chamber 34 that extends the length of the stator core 32 and that is sized to receive a rotor. Additionally, each stator lamination 30 includes a plurality of stator-slots disposed circumferentially about the central aperture. These stator-slots cooperate to receive one or more stator windings 36, which are illustrated as coil ends in FIG. 2, that extend the length of the stator core 32.

In the exemplary motor 10, a rotor assembly 40 resides within the rotor chamber 34. Similar to the stator core 32, the rotor assembly 40 comprises a plurality of rotor laminations 42 aligned and adjacently placed with respect to one another. Thus, the rotor laminations 42 cooperate to form a contiguous rotor core 44. The exemplary rotor assembly 40 also includes rotor end members 46, disposed on each end of the rotor core 44, that cooperate to secure the rotor laminations 42 with respect to one another. When assembled, the rotor laminations 42 cooperate to form shaft chamber that extends through the center of the rotor core 44 and that is configured to receive the rotor shaft 26 therethrough. The rotor shaft 26 is secured with respect to the rotor core 44 such that the rotor core 44 and the rotor shaft 26 rotate as a single entity, the rotor assembly 40. Moreover, a bonding agent (see FIG. 4) disposed between adjacent rotor laminations 42 increases the stiffness and mechanical integrity of the rotor assembly 40, as discussed further below. The exemplary rotor assembly 40 also includes electrically conductive nonmagnetic members, such as rotor conductor bars 48, disposed in the rotor core 44. Specifically, the conductor bars 48 are disposed in rotor channels 49 that are formed by amalgamating features of each rotor lamination 42, as discussed further below. Inducing current in the rotor assembly 40, specifically in the conductor bars 48, causes the rotor assembly 40 to rotate. By harnessing the rotation of the rotor assembly 40 via the rotor shaft 26, a machine coupled to the rotor shaft 26, such as a pump or conveyor, may operate.

To support the rotor assembly 40, the exemplary motor 10 includes front and rear bearing sets 50 and 52, respectively, that are secured to the rotor shaft 26 and that facilitate rotation of the rotor assembly 40 within the stationary stator core 32. During operation of the motor 10, the bearing sets 50 and 52 transfer the radial and thrust loads produced by the rotor assembly 40 to the motor housing. Each bearing set 50 and 52 includes an inner race 54 disposed circumferentially about the rotor shaft 26. The tight fit between the inner race 54 and the rotor shaft 26 causes the inner race 54 to rotate in conjunction with the rotor shaft 26. Each bearing set 50 and 52 also includes an outer race 56 and ball bearings 58, which are disposed between the inner and outer races 54 and 56. The ball bearings 58 facilitate rotation of the inner races 54 while the outer races 56 remain stationary and mounted with respect to the endcaps 14 and 16. Thus, the bearing sets 50 and 52 facilitate rotation of the rotor assembly 40 while supporting the rotor assembly 40 within the motor housing, i.e., the frame 12 and the endcaps 14 and 16. To reduce the coefficient of friction between the races 54 and 56 and the ball bearings 58, the ball bearings 58 are coated with a lubricant.

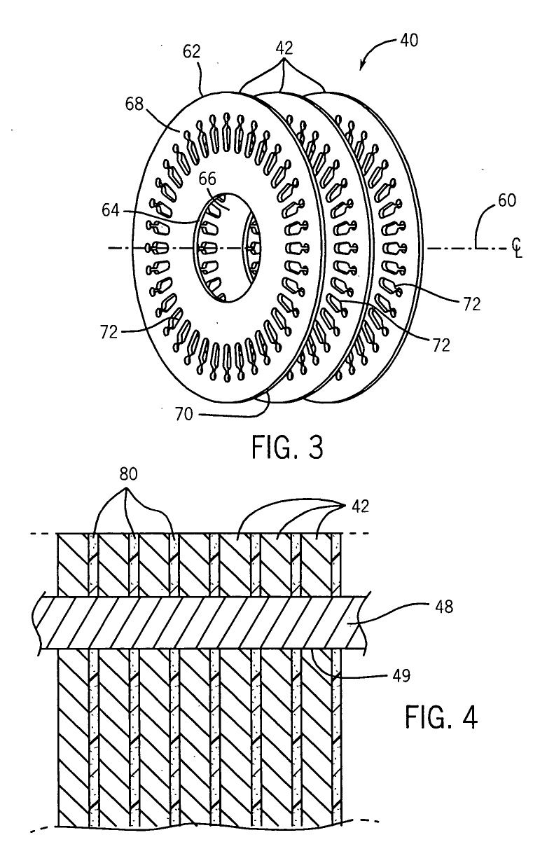

FIG. 3 presents an exploded view of adjacent rotor laminations 42 of a rotor assembly 40. (See FIG. 2.) To maintain symmetry, the rotor laminations 42 are concentrically disposed along an axial centerline 60. That is, the axial centerline 60 passes through the center of each of the rotor laminations 42. Accordingly, the axial centerline 60 provides an axis of rotation for the assembled rotor 40.

The exemplary rotor laminations 42 are formed of a magnetically conductive material, such as steel. Advantageously, to prevent electrical interference with the conductor bars 48 (see FIG. 2), the rotor laminations 42 may be formed of a material having a lower conductivity than the material from which the conductor bars 48 are formed. For example, in the exemplary embodiment, the conductor bars 48 may be formed of copper or aluminum and the rotor laminations may be formed of steel, which has a lesser electrical conductivity than either copper or aluminum. In the exemplary embodiment, each of the rotor laminations 42 are substantially identical to one another. Accordingly, each of the rotor laminations 42 has an outer periphery 62 that defines the generally circular lamination cross-section. Additionally, each lamination has an inner periphery 64 that defines a central and circular shaft aperture 66. Advantageously, the shaft aperture 66 is configured to receive a rotor shaft 26 (see FIG. 2) therethrough. Extending between the outer periphery 62 and the inner periphery 64 are first and second end surfaces 68 and 70, respectively. The end surfaces 68 and 70 are generally parallel to one another and have a flat surface finish, thereby facilitating good tolerances between adjacently placed rotor laminations 42 and, as such, a tight rotor core 44. Additionally, as discussed in detail further below, a bonding agent (see FIG. 4) may be disposed on at least one of the first and second end surfaces 68 and 70 of each lamination 42 to bond adjacent laminations to one another, thereby increasing the stiffness of the rotor core 44 as a whole.

Because the rotor laminations 42 are substantially identical to one another, each rotor lamination 42 includes features that, when aligned with corresponding features of adjacent laminations 42, form cumulative features that extend axially through the rotor core 44. For example, the central apertures 66 of adjacent laminations 42 cooperate to form a shaft chamber that extends through the rotor core and that is configured to receive a rotor shaft (see FIG. 2). Additionally, each rotor lamination 42 includes a series of enclosed rotor-slots 72 arranged in a concentric slot-pattern. For example, in the illustrated rotor laminations 42, thirty-six rotor-slots 72 are arranged at equiangular and symmetric positions with respect to one another. Of course, other patterns and arrangements (e.g., twenty-four slot) are envisaged. When assembled, the rotor-slots 72 of adjacent laminations cooperate to form concentric rotor channels 49 (see FIG. 2) that extend through the rotor core 44. Again, these rotor channels 49 are configured to receive electrically conductive and nonmagnetic members, i.e., conductor bars 48, therethrough. (See FIG. 2.)

Turning to FIG. 4, this figure provides a detailed view of a series of adjacent rotor laminations 42 assembled to form the rotor core 44 of the rotor assembly 40, within line 4-4 of FIG. 2. In the exemplary embodiment, a bonding agent 80 disposed between adjacent rotor laminations 42 bonds adjacent laminations with respect to one another, thereby increasing the stiffness and mechanical integrity of the rotor core 44 and, as such, the rotor assembly 40. For the purposes of illustration, the thickness of the bonding agent layer in comparison to that of the rotor lamination 42 is exaggerated. Indeed, when applied to rotor laminations 42, the thickness of the bonding agent layer is significantly less than that of the rotor laminations 42. Additionally, the bonding agent 80 may be disposed over only a portion of the end surface of the rotor lamination or, alternatively, disposed substantially over the entire end surface. In any event, the bonding agent 80 may comprise a bonding agent resin, such as 3M ScotchCast®, which is available from 3M Corporation of St. Paul, Minn., or a bonding agent epoxy, such as Epoxylite 8899, which is available from Epoxylite Corporation of St. Louis, Mo. Additionally, the bonding agent 80 may comprise a compound that facilitates cold-bonding, i.e., bonding of adhesive at quiescent temperature. Additionally, the bonding agent 80 may be a heat-activated compound. That is to say, a heat-activated compound presents greater bonding agent properties (i.e., activated) upon application of heat from a heat source. Advantageously, the bonding agent 80 may comprise a dielectric material, thereby electrically insulating the rotor laminations 42 with respect to one another. Indeed, a variety of bonding agents and substances are envisaged.

In any case, the bonding agent 80 bonds (cohesively, adhesively, etc.) adjacent laminations 42 with respect to one another. Advantageously, this bonding between adjacent laminations increases the overall stiffness of the laminated rotor core 44. For example, the bonding agent 80 disposed between each of the adjacent rotor laminations 42 may increase the bending stiffness of the rotor core 44 and rotor assembly 42 by two hundred to three hundred percent, and beyond. Moreover, the bonded relationship between adjacent laminations 42 improves the consistency of the stiffness of the rotor core 44. Advantageously, increasing such consistency facilitates modeling of the performance of the rotor assembly 40 during operation. That is to say, improving stiffness consistency within the rotor core 44 and the rotor assembly 42 improves the accuracy of models that are designed to predict the rotor assembly's dynamic performance.

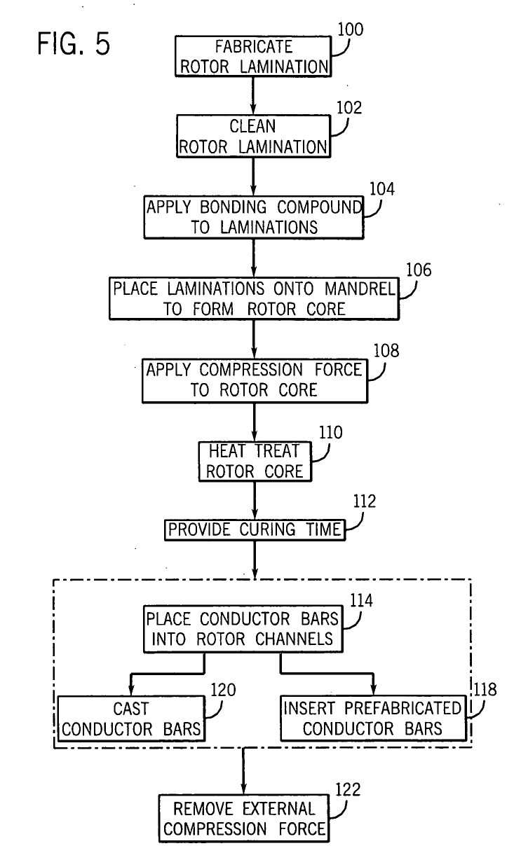

Keeping FIGS. 1-4 in mind, FIG. 5 illustrates in block form an exemplary process for manufacturing a rotor assembly, in accordance with an embodiment of the present technique. The exemplary process includes the act of fabricating a rotor lamination 42. (Block 100.) By way of example, the rotor lamination 42 may be fabricated via a stamping process by which the rotor lamination 42 is fabricated from a sheet of metallic material. Alternatively, the rotor lamination may be formed via a casting process. To remove impurities on the end surfaces 68 and 70, the rotor lamination 42 may be cleaned. (Block 102.) Advantageously, cleaning the rotor laminations 42 facilitates application of the bonding agent 80 to the laminations 42. The bonding agent 80 may be applied to the laminations 42 by dipping the lamination into a container having bonding agent 80 in its liquid form. Alternatively, the bonding agent 80 may be applied to the end surfaces 68 and 70 of each lamination 42 via a spray process. In either event, these acts within the exemplary process are represented by Block 104. To assemble the rotor core 44, the laminations 42 may be placed onto a mandrel. (Block 106.) Advantageously, the mandrel facilitates alignment of the rotor laminations 42 with respect to one another to form the cumulative features discussed above, i.e., the rotor channel 49 and the shaft chamber.

An axial compression force may be applied to the rotor core 44. (Block 108.) Advantageously, the axial compression force forces the rotor laminations 42 closer with respect to one another and, as such, expels excess bonding agent 80. If the bonding agent is a heat-activated compound, the rotor core 44 may be heat treated. (Block 110.) In any event, a sufficient curing time is provided to bond the laminations to one another. (Block 112). After the curing is completed, the external compression force is removed. The exemplary process also includes placing conductor bars 48 into the rotor core 44. (Block 114.) As one example, prefabricated bars, which are typically shaped to match the shape of the rotor-slots 64, are inserted into the rotor channels 49. (Block 118.) Rotor assemblies 40 assembled via this process are typically identified as fabricated rotors. Alternatively, the conductor bars 48 may be formed by placing molten conductive material into the rotor channels 49 and subsequently cooled. (Block 120.) Rotors fabricated via this process are typically identified as cast rotors. In any event, after the rotor manufacturing is completed, the rotor 40 may be inserted into the motor 10.

While only certain features of the technique have been illustrated and described herein, many modifications and changes will occur to those skilled in the art. It is, therefore, to be understood that the appended claims are intended to cover all such modifications and changes as fall within the true spirit of the technique.

1. A lamination for a rotor, comprising:
an outer periphery defining a generally circular lamination cross-section;
an inner periphery defining a central aperture configured to receive a rotor shaft therethrough;
first and second end surfaces extending from the outer periphery to the inner periphery, wherein the first and second end surfaces are generally parallel to one another;
a plurality of rotor-slots disposed concentrically about the central aperture and extending from the first end surface to the second end surface generally transverse to the lamination cross-section; and
a room temperature bonding agent disposed on at least one of the first and second end surfaces.

2. (canceled)

3. The lamination as recited in 1, wherein the bonding agent comprises an epoxy-based resin.

4. The lamination as recited in 1, wherein the rotor slots are skewed with respect to the rotor lamination.

5. The lamination as recited in claim 1, wherein the rotor-slots are perpendicular to the lamination cross-section.

6. (canceled)

7. The lamination as recited in claim 1, wherein the bonding agent substantially covers at least one of the first or second end surface.

8. A rotor for use in an electrical machine, comprising:
a rotor core comprising a plurality of rotor laminations and having a generally circular core cross-section, each rotor lamination having a central aperture and a plurality of enclosed rotor-slots that are concentrically arranged about the central aperture and that each extends longitudinally through the rotor lamination generally transverse to the core cross-section, wherein the central apertures of adjacent rotor laminations cooperate to form a shaft chamber and the enclosed rotor-slots of adjacent laminations cooperate to form a plurality of rotor channels;
a rotor shaft disposed in the shaft chamber such that the rotor shaft is secured with respect to the rotor core;
a plurality of electrically conductive members disposed in the rotor channels; and
a bonding agent disposed between at least one pair of adjacent rotor laminations and configured to bond the at least one pair of adjacent rotor laminations to another, wherein the bonding agent cures at room temperature.

9. The rotor as recited in claim 8, wherein the electrically conductive members comprise aluminum.

10. The rotor as recited in claim 8, wherein the electrically conductive members comprise copper.

11. (canceled)

12. The rotor as recited in claim 8, wherein the bonding agent comprises an epoxy-based resin.

13. The rotor as recited in claim 8, wherein the bonding agent substantially covers a first or second end surface of a rotor lamination of the plurality of rotor laminations.

14. The rotor as recited in claim 8, wherein the rotor-slots are perpendicular to the lamination cross-section.

15. A rotor for use in an electrical machine, comprising:
a rotor core comprising a plurality of rotor laminations and having a generally circular core cross-section, each rotor lamination having a central aperture and a plurality of rotor-slots that are concentrically arranged about the central aperture and that each extends longitudinally through the rotor lamination generally transverse to the core cross-section such that the central apertures of adjacent rotor laminations cooperate to form a shaft chamber and the rotor-slots of adjacent laminations cooperate to form a plurality of rotor channels, wherein at least one pair of adjacent laminations are bonded to one another via an epoxy-based resin configured to cure at room-temperature;
a rotor shaft disposed in the shaft chambers such that the rotor shaft is secured with respect to the rotor core; and
a plurality of electrically conductive members disposed in the rotor channels.

16. (canceled)

17. The rotor as recited in claim 15, wherein the rotor core is configured for high-speed operation.

18. An electrical machine, comprising:
a stator core having a rotor chamber configured to receive a rotor and including a plurality of stator windings configured to receive power from a power source;
a rotor disposed in the rotor chamber, the rotor comprising:
a rotor core comprising a plurality of rotor laminations and having a generally circular core cross-section, each rotor lamination having a central aperture and a plurality of rotor-slots that are concentrically arranged about the central aperture and that each extends longitudinally through the rotor lamination generally transverse to the core cross-section, wherein the central apertures of adjacent rotor laminations cooperate to form a shaft chamber and the rotor-slots of adjacent laminations cooperate to form a plurality of rotor channels;
a rotor shaft disposed in the shaft chambers such that the rotor shaft is secured with respect to the rotor core;
a plurality of electrically conductive members disposed in the rotor channels; and
a bonding agent disposed between at least one pair of adjacent rotor laminations and configured to bond the at least one pair adjacent rotor laminations to another wherein the bonding agent is configured for cold-bonding.

19. The electrical machine as recited in claim 18, wherein the power source comprises an alternating current (ac) power source.

20. The electrical machine as recited in claim 19, wherein the power source comprises a three-phase power source.

21. The electrical machine as recited in claim 19, wherein the power source comprises a pulse width modulation (PWM) inverter.

22. The electrical machine as recited in claim 18, comprising the power source.

23. The electrical machine as recited in claim 18, wherein the rotor is configured for high-speed operation.

24. (canceled)

25. The electrical machine as recited in claim 18, wherein the bonding agent comprises an epoxy-based resin.

26-37. (canceled)
